(19) United States
(12) Patent Application Publication
(10) Pub. No.: US 2005/0023721 A1
(43) Pub. Date: Feb. 3, 2005

(54) Method of fabricating a mandrel for cobond assembly

(75) Inventor: Kenneth D. Cominsky, Mansfield, TX (US)

Correspondence Address: Robert C. Klinger;Jackson Walker L.L.P., Suite 600, 2435 N. Central Expressway, Richardson, TX, 75080, US

(73) Assignee: Lockheed Martin Corporation

(21) Appl. No.: 10/926,700

(22) Filed: Aug. 26, 2004

Related U.S. Application Data
(63) Continuation of application No. 09/801,461, filed on Mar. 8, 2001.

(51) Int. Cl. B29C 33/40; B29C 35/08; B29C 41/02; B29C 45/00

(52) U.S. Cl. 264/219; 264/401; 264/328.1; 264/236; 264/334; 264/328.2; 425/174.4; 425/542

(57) ABSTRACT

A method and system for fabricating mandrels which are used as pressure intensifiers for cobonding or consolidation fabrication of composite assemblies. Mandrel molds are created using rapid prototyping, such as stereolithography, generated directly from a virtual model which is created with a processor aided design type program requiring little or no engineering drawings. A curable fluid material is then injected into a mold cavity which defines the mandrel. The mandrel can be applied in a specific process for cobonding cured detailed parts using an uncured element enabling intensified pressure to the joint or fillet area during the bonding process.

### CLAIM OF PRIORITY

The present application is a continuation application of, and claims the benefit of U.S. patent application Ser. No. 09/801,461 filed Mar. 8, 2001, and entitled “MANDREL FABRICATION FOR COBOND ASSEMBLY,” the teachings of which are incorporated by reference herein.

### STATEMENT OF GOVERNMENT SUPPORT

This invention was made with Government support under Contract Number F33615-94-C-3210 awarded by The Department of the Air Force. The Government has certain rights in this invention.

### TECHNICAL FIELD OF THE INVENTION

The present invention relates generally to the field of fabrication tooling and, more particularly, to fabrication of high performance tooling for bonding processes.

### DESCRIPTION OF RELATED ART

Composite products, spanning in production for the last fifty years, are utilized in industries such as automotive, commercial aircraft, boating, sports equipment and any other production industries utilizing thermosetting fiber/resin material systems. The structural integrity of composite laminates is severely compromised when such laminates are drilled or cut such as for the purpose of attachment. A hole or aperture in the laminate tends to compromise the integrity of the laminate and provides a site for structural failure.

In high-performance applications, such as aerospace structures, a typical composite may comprise a mat of interwoven high modulus filaments impregnated with a polymer. The drilling of such a laminate to provide a means of attachment destroys the continuity of the structural filaments contained within the composite.

Composite structures can also be attached by co-curing the structures with a similar joint material. However, this process is very time consuming, expensive, and often results in a composite joint with a structural integrity of much less than that of the joining structures.

The present invention provides a pressure intensifier to enable structurally sound bonding of composite structures avoiding the aforementioned attachment problems.

### SUMMARY OF THE INVENTION

The present invention achieves technical advantages as a method for fabricating mandrels which are used as pressure intensifiers for cobonding or consolidation fabrication of composite assemblies. Mandrel molds are created using rapid prototyping, such as stereolithography, generated directly from a virtual model which is created with a processor aided design type program requiring little or no engineering drawings. The mandrel can be applied in a specific process for cobonding cured detailed parts using an uncured element enabling intensified pressure to the joint or fillet area during the bonding process.

### BRIEF DESCRIPTION OF THE DRAWINGS

For a more complete understanding of the present invention, reference is made to the following detailed description taken in conjunction with the accompanying drawings, wherein like numerals refer to like elements, wherein:

FIG. 1A illustrates consolidation fabrication in accordance with the present invention;

FIG. 1B illustrates a pressure intensifier in accordance with an exemplary embodiment of the present invention;

FIG. 2 shows a flow chart of an exemplary method of fabricating a pressure intensifier or mandrel for use in consolidation fabrication in accordance with the present invention;

FIG. 3 illustrates a prospective view of an embodiment of a two part mandrel mold design in accordance with the present invention;

FIG. 4 illustrates a prospective view of an alternative embodiment of a mandrel mold design which has been separated into multiple component molds; and

FIGS. 5A and 5B illustrate exemplary mandrels as they are applied to exemplary structural joint areas in accordance with an embodiment of the present invention.

### DETAILED DESCRIPTION OF THE PREFERRED EMBODIMENT

The numerous innovative teachings of the present application will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others.

Referring now to FIG. 1A there is illustrated consolidation fabrication in accordance with an embodiment of the present invention. In a cobonding or consolidation fabrication process, two or more cured composite structures 205, 210 are bound together via an uncured portion 215. Fully cured aircraft ribs, webs, and skins, for example, are joined together via staged or uncured woven preforms 215. The woven preform 215 is configured to the joint shape required for the specific fillet 220 and the bonding structures 205, 210 are positioned in or on the woven preform 215. Subsequently, the assembly is then either locally bagged or completely bagged and autoclave cured under pressure. Despite the pressure supplied force to the fillet area 220 during the autoclave curing, the preform 215 does not always adhere sealingly and securely to the cured elements 205, 210, especially in the fillet area 220 where the vertical element 205 meets a horizontal element 210. The quality of the resultant preform joint after curing is critical to performance of the assembled component. Fillet definition is exceptionally important since most performance failures occur in the fillet area 220.

Referring now to FIG. 1B there is illustrated a pressure intensifying device, also referred to as a pressure intensifier or mandrel, in accordance with an exemplary embodiment of the present invention. A cure tool or mandrel 230 utilized in a cobonding or consolidation fabrication process can provide better definition and more securely adhere the preforms. The mandrel 230 acts as a pressure intensifier to ensure good consolidation in the area of the fillet. In a preferred embodiment, the pressure intensifier or mandrel 230 has a shape corresponding to that of the fillet area and is made from a rubber or similar type material which deforms under autoclave pressure. The deforming rubber advantageously minimizing the impact of manufacturing tolerances and tool fit-up due to material bulk-up in the cured and uncured composite detail parts allowing a certain degree of tolerance in the shape of the mandrel 230 with respect to the fillet area for which it was designed. In a cobonding process using the mandrel 230, the cured structures 205, 210 are positioned on or in the woven preform 215 and the mandrel 230 is positioned in the fillet area over the uncured details. The assembly is then either locally bagged or completely bagged and autoclave cured under pressure. Under pressure, the mandrel 230 intensifies the pressure in the uncured fillet area and enables a stronger bond between the bonding structures 205, 210 following curing of the preform.

The ratio of radii 232 and 234 in the mandrel 230 can be selected to improve the part definitions in the fillet area. Preferably, the mandrel 230 is designed with a specific ratio of radii, as to design a large, outside radius 232 to act as a pressure multiplier (ratio of areas) to the smaller radius 234 and therefore consolidate the composite preform well. An exemplary ratio of radii 232 and 234 is R0.75 and R-0.03 respectively.

Rubber type parts can be fabricated by pouring or injecting rubber, as a fluid, into a metal or wood tool, for example, which is configured to simulate a rib and a skin, for example, intersecting at an arbitrary angle. The tool works essentially as a mold, allowing the rubber to cure into such a configuration, however, metal or wood molds typically require a machining processes to define the required shape. Conventional machine tool subtractive methods typically involve a large initial expense for engineering drawing and setting up the proper machining protocol and tools. As such, the set-up time is not only expensive, but relies a great deal on human judgment and expertise. Another difficulty associated with such conventional machine tool subtractive processes is the difficulty or impossibility of making many part configurations. Where a desired part is unusual in shape, the machining becomes more difficult. In many cases, a particular part configuration is not possible because of the limitations imposed upon the cutting tool placement on the part. These problems are exacerbated where only a small number of parts are desired. For example, an aircraft has many joint and corner areas which define the intersection of component parts which make-up the aircraft. Analyzing the cost and time attributed to every corner or edge being adhered to, it is appreciable to consider that a special tool or pressure intensifier must be designed, developed and manufactured for every unique joint and corner for that adhesion to take place. Rarely are two comers or joints exactly the same dimensions, thereby making production of a single composite structure, such as an aircraft fuselage, dependent upon a great deal of additional engineering. Such complexities substantially increase the cost of complex articles or entities, such as contoured aircraft, for example. Casting and extrusion techniques are also inefficient for many of the same reasons.

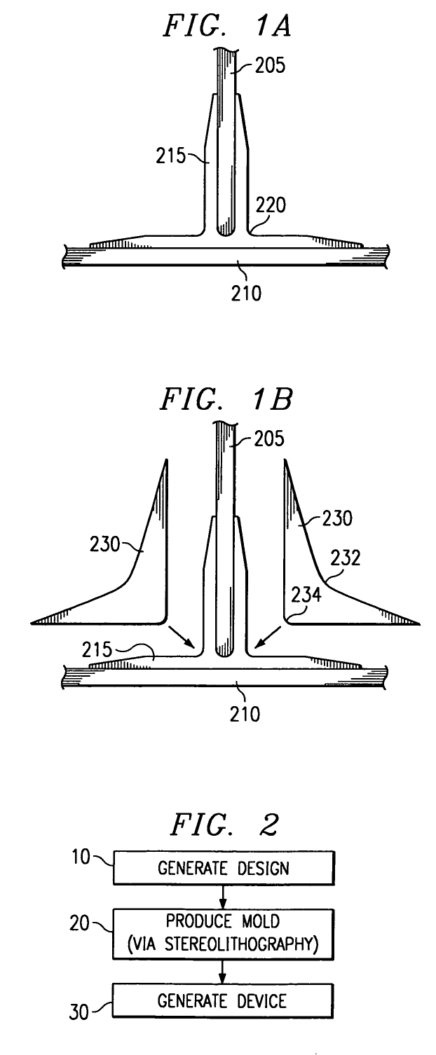

FIG. 2 shows a flow chart of an exemplary method of fabricating a pressure intensifier or mandrel for use in consolidation fabrication in accordance with the present invention. An electronic design for a pressure intensifier mold is generated 10 via a computer aided type program. Such programs include, but are not limited to CATUAM Autocad, ProEngineer and Unigraphics, for example. The pressure intensifier mold design includes a cavity which defines the net shape for a mandrel and corresponding fillet area. The mold design can be separated into multiple parts for ease of manufacturing and separation to expose a molded part. For multiple part designs, the edges of the mold are designed and configured to closely mate allowing for simple sealing using adhesive tape, for example, during injection of a fluid material for molding. The electronic design can be stored in a data file, for example, capable of being read by a rapid-prototyping machine such as a stereolithographic machine.

The replica mold is formed via a rapid-prototyping process such as stereolithography (SLA) 20. SLA is known in the art to produce a physical, three dimensional object using data from a data file. The replica mold is generated directly from the data file and therefore requires no engineering drawings. A stereolithography machine can use, for example, a computer controlled laser to cure a photo-sensitive resin, layer-by-layer, to create the prototype. SLA is “rapid-modeling” since the objects typically generated from existing photo-sensitive resins or photopolymers do not have the physical, mechanical, or thermal properties typically required of end-use production materials. However, stereolithography is capable of producing extremely complex parts with reduced design effort (i.e., no drawings are required). Parts are made directly from the CATIA solids in a relatively short time and for minimal expense compared to current mill tooled or sandcast methods.

The mandrel or pressure intensifier is formed 30 by pouring a suitable fluid material into the mold and curing. Such suitable materials include, but are not limited to, rubbers such as room temperature vulcanizing (RTV) rubbers, silicones, non-hardening polymers or materials exhibiting similar characteristics, for example. The use of RTV rubbers provides for a device which is inexpensive to reproduce and which conforms under autoclave pressure to the parts to which they are located. For multiple part molds, mating edges are first sealed to prevent the fluid material from escaping prior to curing or hardening. Subsequent to curing of the fluid material, the mold is removed from the new mandrel.

Since stereolithography machines can have limitation to the size of parts that can be produced, the pressure intensifier design can be separated into smaller multiple component parts. Following fabrication of the mold and curing of the fluid material, the smaller corresponding cured mandrels can be joined prior to application in the consolidation fabrication process.

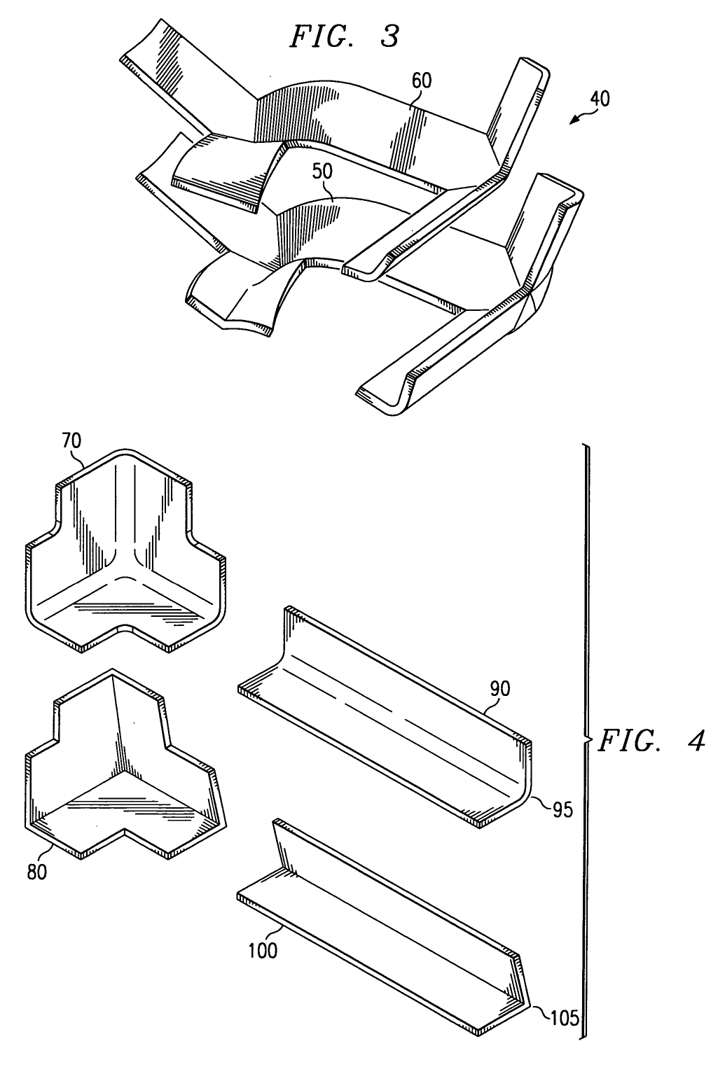

FIG. 3 illustrates a prospective view of an embodiment of a two part mandrel mold design 40 which illustrates the complexity which can be required. Backside mold half 50 and front side mold half 60 are pressed or mated together to form an internal cavity which defines a specific mandrel. In this exemplary embodiment, the mating edges should be sealed, with a removeable tape for example, prior to injecting or pouring the fluid mandrel material inside. It is important to note not only that stereolithography tooling can be reproduced at any time directly from CAD/CAM models, but that stereolithography tooling can produce complex tooling which may not be producible via alternate processes such as conventional milling.

FIG. 4 illustrates a prospective view of an alternative embodiment of a mandrel mold design which has been separated into component molds with a first comprising mold halves 70 and 80 and a second comprising mold halves 90 and 100. The first mold 70 and 80, forms a cavity defining mandrel that is used to fabricate a corner intersection of three cured composite details. The second mold 90 and 100, forms a cavity defining a mandrel that is used to join the straight sections of two of these cured composite details. Mandrels formed with the first and second molds can be bonded together, via a silicone-based or acrylic adhesive for example, to form a larger composite mandrel. In this manner, multiple mandrels made from the same stereolithographic molds may be used in various locations in a complex composite assembly. As aforementioned, the large topside radius 95 acts as a pressure multiplier (ratio of areas) to the smaller radius 105 which improves consolidation of the composite preform during the autoclave process.

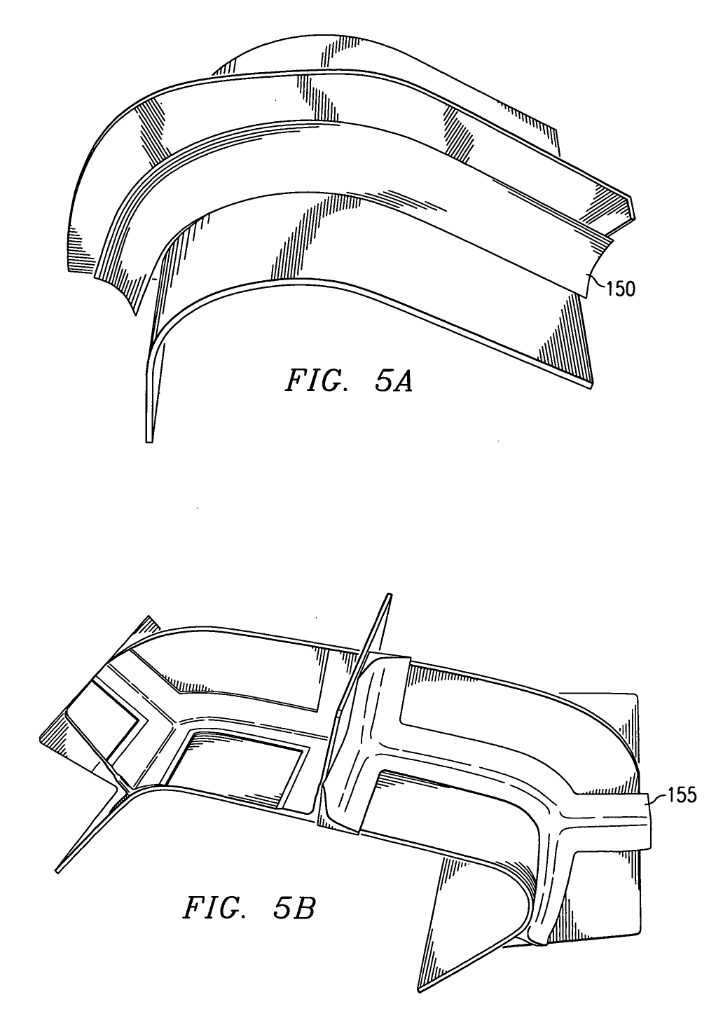

Referring now to FIGS. 5A and 5B there are illustrated exemplary mandrels as they are applied to exemplary structural joint areas. FIG. 5A particularly illustrates a single piece mandrel and FIG. 5B illustrates a complex mandrel in which corner pieces and straight pieces can be made by separate molds and subsequently joined.

Although preferred embodiments of the method and system of the present invention has been illustrated in the accompanied drawings and described in the foregoing detailed description, it is understood that obvious variations, numerous rearrangements, modifications and substitutions can be made without departing from the spirit and the scope of the invention as defined by the appended claims.

1. A method of fabricating a mold and a corresponding mandrel, comprising:
configuring a computer with computer design software to generate a data file representative of a virtual mold having at least two portions joinable to form an injection cavity which defines a mandrel;
fabricating a mold from a rapid prototyping fabrication process using the data file representative of said virtual mold;
injecting a curable fluid material into said injection cavity formed when said joinable mold portions are mated together;
curing said injected fluid material; and
removing said cured mandrel from said mold.

2. The method of claim 1, wherein a stereolithography apparatus is used to fabricate the mold.

3. The method of claim 1, further comprising using a room temperature vulcanizing silicone as the injected fluid material.

4. The method of claim 1, further comprising designing the joinable mold portions with sealable mating edges.

5. The method of claim 4, further comprising sealing said edges of said mated joinable mold portions for preventing said injected fluid material from escaping.

6. The method of claim 1 further comprising joining at least two cured mandrels to form a composite mandrel.

7. A mold made by the method of claim 1.

8. A mandrel made by the method of claim 1.

9. The method of claim 8 wherein said mandrel is used as a pressure intensifier.

10. A pressure intensifier mold and corresponding mandrel made by the method of claim 1.

11. A method for fabricating a pressure intensifying mold and corresponding mandrel, comprising:
configuring a computer having a processor and memory to operate a computer aided design program;
using the computer running the computer aided design program to generate a data file representing a virtual mold of a pressure intensifying mandrel;
transmitting the data file representing the virtual mold to a rapid prototyping apparatus;
using the data file in the rapid prototyping apparatus to fabricate a corresponding three dimensional mold of a pressure intensifying mandrel; and
injecting a curable fluid material in said mold to form a pressure intensifying mandrel.

12. The method of claim 11, further comprising using a stereolithography apparatus to fabricate the mold.

13. The method of claim 11, wherein said mold comprises joinable mold portions designed and fabricated having sealable mating edges.

14. The method of claim 13, wherein said sealable mating edges are temporarily sealed to prevent said injected fluid material from escaping said injection cavity.

15. A mold made by the method of claim 11.

16. A pressure intensifying mandrel made by the method of claim 11.

17. A plurality of pressure intensifying mandrels made by the method of claim 11.

18. The plurality of pressure intensifying mandrels of claim 17, wherein said pressure intensifying mandrels are coupled by joint cement to fabricate a composite pressure intensifying mandrel.

19. A pressure intensifying device fabricated by a method, comprising:
designing a virtual mold having at least two portions joinable to form an injection cavity which defines said pressure intensifying device;
fabricating a three dimensional mold from a rapid prototyping process using a data file representative of said virtual mold;
injecting a fluid material into said injection cavity formed by joining said joinable mold portions; and
curing said injected fluid material.

20. The method of claim 19, wherein the virtual mold is designed using a computer having a processor and a memory;
said computer being configured to run a computer design program;
said computer and computer design program being adapted to generate a virtual representation data file of an intensifying pressure device; and
said computer adapted to output a generated virtual representation data file of a intensifying pressure device.

21. A pressure intensifying device made by the method of claim 20.

22. The method of claim 21, further comprising:
configuring said pressure intensifying device to have an inner surface;
configuring said pressure intensifying to have an outer surface substantially parallel to said inner surface;
configuring the inner surface to have a first radius corresponding to an abutment; and
configuring said outer surface to have a second radius which is greater than said first radius.

23. The method of claim 22, wherein said inner and outer surfaces are cooperable for increasing pressure to a bound area when said inner surface is applied to said bound area and a pressure is applied to said outer surface.
